(19) United States
(12) Patent Application Publication
(10) Pub. No.: US 2024/0403955 A1
(43) Pub. Date: Dec. 5, 2024

(54) ELECTRONIC APPARATUS FOR PROVIDING INFORMATION RELATED TO ASSET PRICE AND METHOD THEREFOR

(71) Applicant: Dunamu Inc., Seoul (KR)

(72) Inventor: Hyunho JEON, Seoul (KR)

(21) Appl. No.: 18/667,817

(22) Filed: May 17, 2024

(30) Foreign Application Priority Data
Jun. 1, 2023 (KR) 10-2023-0071146

(51) Int. Cl. G06Q 40/04; G06Q 40/06

(52) U.S. Cl. CPC G06Q 40/04; G06Q 40/06

(57) ABSTRACT

A method of providing information about asset price is disclosed. The method includes obtaining time series data for a first period for a price of a first item. The method includes setting a second period with unit times within the first period. The method includes setting an extraction frequency of an extremum point for the price of the first item during the second period. The method includes initially setting a time variable, a price variable and a search direction variable related to the time series data. The method includes updating the time variable, the price variable or the search direction variable in each of the unit times under the extraction frequency during the second period, and searching for the extremum point in the time series data during the second period. The method includes generating extremum point data including the extremum point and a timepoint corresponding to the extremum point.

### CROSS-REFERENCE TO RELATED APPLICATION(S)

This application claims the benefit of Korean Patent Application No. 10-2023-0071146, filed on Jun. 1, 2023, in the Korean Intellectual Property Office, the disclosure of which is incorporated herein by reference.

### BACKGROUND

### Technical Field

Example embodiments relate to a method for providing information related to asset prices to users of a service related to asset investment, and an electronic apparatus performing the same.

### Description of the Related Art

Many people have fears about investing in assets. For example, stockholders constantly contemplate whether the stock price of their stock will drop further or whether they should sell it now, and non-stockholders contemplate whether to buy in haste before the stock price rises further. To overcome this, some investors try to invest with more confidence with regard to the direction of uncertain assets through various technical analyses.

However, technical analysis itself is unfamiliar and difficult, and there are barriers to entry. In fact, technical analysis often does not work, so most investors express skepticism about technical analysis. Even in many stock apps, technical analysis or technical indicators that support the technical analysis are only complicatedly explained, and many stock apps also do not provide interfaces that appeal to users, so the technical analysis or technical indicators are not properly considered when users invest.

### BRIEF SUMMARY

For smarter investment, data that has a significant impact on the future flow of assets should be provided to users, and it is beneficial to intuitively and kindly provide how such data was derived. Further, it is also beneficial to show that investments using the data are paying off over time.

An aspect provides a method of providing additional information about an item or related items or indices using the price data of the item, and an electronic apparatus therefor.

Additional features and advantages of the disclosure will be set forth in the description which follows, and in part will be apparent from the description, or may be learned by practice of the disclosure. The objectives and other advantages of the disclosure will be realized and attained by the structure particularly pointed out in the written description and claims hereof as well as the appended drawings.

According to an aspect, there is provided a method of an electronic apparatus providing information related to an asset price, including obtaining time series data for a first time period for a price of a first item, setting a second time period with a plurality of unit times within the first time period, setting an extraction frequency of an extremum point for the price of the first item during the second time period, initially setting a time variable, price variable and a search direction variable related to the time series data, the search direction variable corresponding to a type of the extremum point to be searched, updating the time variable, the price variable or the search direction variable in each of the unit times under the extraction frequency during the second time period, and searching for the extremum point in the time series data during the second time period, generating extremum point data including the extremum point and a timepoint corresponding to the extremum point.

According to an example embodiment, the extraction frequency may be set for each detailed time period including one or more unit times in the second time period, and the extraction frequency that is set for each detailed time period may be set based on at least one of volatility, a highest price and a lowest price of the first item for the each detailed time period.

According to an example embodiment, the extraction frequency may be set according to an asset market in which the first item is traded, a type of asset corresponding to the first item or an identifier of the first item.

According to an example embodiment, the time variable may include a first timepoint which is a reference timepoint for determining the extremum point and a second timepoint which is a search timepoint for the extremum point, and the price variable may include a temporary extremum point for the price of the first item.

According to an example embodiment, the searching for the extremum point may include moving the second timepoint by a unit time from the first timepoint, comparing the temporary extremum point with a price of the second timepoint to determine whether to update the temporary extremum point, if the temporary extremum point is updated, moving the second timepoint by the unit time, if the temporary extremum point is not updated, determining whether a price of the first timepoint is the extremum point by comparing the price of the first timepoint, the price of the second timepoint and the temporary extremum point according to a search direction corresponding to the search direction variable, if the price of the first timepoint is determined to be the extremum point, updating the temporary extremum point, the search direction variable and the first timepoint, and if it is determined that the price of the first timepoint is not the extremum point, moving the second timepoint by the unit time.

According to an example embodiment, the determining whether to update the temporary extremum point may include, if the price of the second timepoint is lower than a temporary low that is the temporary extremum point, updating the temporary low with the price of the second timepoint, and if the price of the second timepoint is higher than a temporary high that is the temporary extremum point, updating the temporary high with the price of the second timepoint.

According to an example embodiment, the determining whether a price of the first timepoint is the extremum point may include, if a first price ratio based on the temporary extremum point and the price of the first timepoint and a second price ratio based on the temporary extremum point and the price of the second timepoint are greater than or equal to a reference ratio that is set according to the extraction frequency, determining the price of the first timepoint as the extremum point, and if at least one of the first price ratio and the second price ratio is less than the reference ratio, determining that the price of the first timepoint is not the extremum point.

According to an example embodiment, the first price ratio may be calculated by dividing a difference between the price of the first timepoint and the temporary extremum point by the price of the first timepoint, and the second price ratio may be calculated by dividing a difference between the price of the second timepoint and the temporary extremum point by the price of the second timepoint.

According to an example embodiment, the updating may include, if the price of the first timepoint is determined to be a high that is the extremum point, setting a temporary low that is the temporary extremum point as a price of a new first timepoint, setting the price of the second timepoint as a temporary high that is the temporary extremum point and updating the search direction variable, and if the price of the first timepoint is determined to be a low that is the extremum point, setting the temporary high as a price of a new first timepoint, setting the price of the second timepoint to a new temporary low and updating the search direction variable.

According to an example embodiment, the method may further include obtaining technical indicator data corresponding to the extremum point data, training an analysis model based on the extremum point data and the technical indicator data, and inferring whether a price of the first item or a second item at a selected (or predetermined) timepoint is the extremum point by using the analysis model.

According to an example embodiment, the technical indicator data may include at least one of moving average convergence & divergence (MACD), disparity in long-term moving average (MA), disparity in short-term MA, a relative strength index (RSI), a stochastic index, a directional moving index (DMI) and a position of a price on a Bollinger band.

According to an example embodiment, the training the analysis model may include inputting the technical indicator data matched with the extremum point data into the analysis model, and training the analysis model based on an ensemble technique.

According to an example embodiment, the inferring may include inputting the technical indicator data at the selected (or predetermined) timepoint to the analysis model, and outputting whether the price at the selected (or predetermined) timepoint is the extremum point based on the technical indicator data at the selected (or predetermined) timepoint.

According to an example embodiment, the extremum point data may include data labeled with strength of the extremum point, and the inferring may include inferring whether the price at the selected (or predetermined) timepoint is the extremum point, and if the price at the selected (or predetermined) timepoint is inferred as the extremum point, may further include inferring strength of the extremum point.

According to an example embodiment, the method may further include providing a user terminal with an inference result of the analysis model including whether the price at the selected (or predetermined) timepoint is the extremum point.

According to an example embodiment, the inference result of the analysis model may further include at least some of the strength of the extremum point and strength of technical indicators corresponding to the selected (or predetermined) timepoint.

According to an example embodiment, the method may further include controlling an user terminal in order for chart information on a price of the first item during the first time period and chart information on technical indicator data of the first item during the first time period to be displayed together on a screen of the user terminal.

According to another aspect, there is provided an electronic apparatus of providing information related to an asset price, including at least one processor and a memory configured to store one or more instructions executed by the at least one processor, wherein the at least one processor, by executing the one or more instructions, is configured to obtain time series data for a first time period for a price of a first item, set a second time period with a plurality of unit times within the first time period, set an extraction frequency of an extremum point for the price of the first item during the second time period, initially set a time variable, a price variable and a search direction variable related to the time series data, the search direction variable corresponding to a type of the extremum point to be searched, update the time variable, the price variable or the search direction variable in each of the unit times under the extraction frequency during the second time period, and search for the extremum point in the time series data during the second time period, and generate extremum point data including the extremum point and a timepoint corresponding to the extremum point.

Additional aspects of example embodiments will be set forth in part in the description which follows and, in part, will be apparent from the description, or may be learned by practice of the disclosure.

According to example embodiments, by extracting an extremum point of the price with use of time series data on the price of the asset, it is possible to identify the right time to invest in fluctuations of asset price over time and use it as reference data for future investments.

Further, according to example embodiments, by training an AI-based model through extracted extremum points and related data and by inferring whether the asset price at a specific point is an extremum point with the use of the trained model, it is possible for a user to easily figure out whether the price at a specific timepoint is suitable for asset investment and furthermore, it is possible to easily figure out how to invest assets.

Further, according to example embodiments, by providing users with technical indicators which are the basis of inference, in various forms such as bar graphs, line graphs and decimal point values, it is possible to give credibility as an explainable analysis by exposing the process and basis of inferring to the users and to arouse interest in users as a new type of service.

Effects of the present disclosure are not limited to those described above, and other effects may be made apparent to those skilled in the art from the following description.

### BRIEF DESCRIPTION OF THE SEVERAL VIEWS OF THE DRAWINGS

These and/or other aspects, features, and advantages of the disclosure will become apparent and more readily appreciated from the following description of example embodiments, taken in conjunction with the accompanying drawings of which:

FIG. 1 is a schematic configuration diagram illustrating an environment in which an electronic apparatus operates according to an example embodiment;

FIG. 2 is a flowchart of a method for providing price-related information according to a first example embodiment;

FIGS. 3 to 5 are flowcharts of a method for providing price-related information specified based on the first example embodiment;

FIGS. 6A to 6G are exemplary diagrams illustrating a process of determining an extremum point of a price according to a search direction;

FIG. 7 is a flowchart illustrating an additional example embodiment of inferring whether a price at a specific timepoint is an extremum point based on the first example embodiment;

FIG. 8 illustrates technical indicator data used for training an analysis model;

FIGS. 9 to 14 illustrate a process of calculating some of technical indicator data;

FIG. 15 is a flowchart of an example embodiment of operation S702 related to the training of the analysis model;

FIG. 16 is a diagram for explaining an example embodiment of a training algorithm of an analysis model;

FIG. 17 is a flowchart of an example embodiment of operation S703 related to inference of the analysis model;

FIG. 18 is a flowchart illustrating an additional example embodiment for providing information to a user terminal based on the example embodiment of FIG. 7;

FIG. 19 is a flowchart of a method for providing price-related information according to a second example embodiment;

FIG. 20 is a flowchart of an additional example embodiment based on the first and second example embodiments;

FIGS. 21A to 21C are exemplary diagrams in which extremum point data generated for a price of a specific item is displayed on a price chart;

FIG. 22 is an exemplary diagram illustrating a process of training and inferring of an analysis model;

FIGS. 23 and 24 are exemplary diagrams displaying inferred extremum points on price charts;

FIGS. 25 to 27 illustrate price-related information displayed on a screen of a user terminal; and

FIG. 28 is a block diagram of an electronic apparatus according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof. Unlike used in the illustrated embodiments, the terms may not be clearly distinguished in specific operations.

Expression “at least one of a, b and c” described throughout the specification may include “a alone,” “b alone,” “c alone,” “a and b,” “a and c,” “b and c” or “all of a, b and c.”

In the present disclosure, a “terminal” or a “user terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication apparatus ensuring portability and mobility, and include (but is not limited to) any type of handheld wireless communication apparatus, for example, a tablet PC, a smartphone, a communication-based terminal such as international mobile telecommunication (IMT), code division multiple access (CDMA), W-code division multiple access (W-CDMA), long term evolution (LTE), or the like.

In the following description, terms “transmission,” “communication,” “sending,” “receiving” and other similar terms not only refer to direct transmission of a signal or information from one component to another component, but may also include transmission via another component.

In particular, to “transmit” or “send” a signal, a message or information to an element may indicate a final destination of the signal, a message or information, and may not imply a direction destination. The same is applied to in “receiving” a signal, a message or information. In addition, in the present disclosure, when two or more pieces of data or information are “related,” it indicates that when one piece of data (or information) is obtained, at least a part of the other data (or information) may be obtained based thereon.

Further, terms such as first and second may be used to describe various components, but the above components should be not limited by the above terms. The above terms may be used for the purpose of distinguishing one component from another component.

For example, without departing from the scope of the present disclosure, a first component may be referred to as a second component. Similarly, the second component may also be referred to as the first component.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without obscuring the gist of the present disclosure by omitting unnecessary description.

For the same reason, some elements are exaggerated, omitted or schematically illustrated in the accompanying drawings. In addition, the size of each element does not fully reflect the actual size. In each figure, the same or corresponding elements are assigned the same reference numerals.

Advantages and features of the present disclosure, and a method of achieving the advantages and the features will become apparent with reference to the example embodiments described below in detail together with the accompanying drawings. However, the present disclosure is not limited to the example embodiments disclosed below, and may be implemented in various different forms. The example embodiments are provided only so as to render the present disclosure complete, and completely inform the scope of the present disclosure to those of ordinary skill in the art to which the present disclosure pertains. The present disclosure is only defined by the scope of the claims. Like reference numerals refer to like elements throughout.

In this case, it will be understood that each block of a flowchart diagram and a combination of the flowchart diagrams may be performed by computer program instructions. The computer program instructions may be embodied in a processor of a general-purpose computer or a special purpose computer, or may be embodied in a processor of other programmable data processing equipment. Thus, the instructions, executed via a processor of a computer or other programmable data processing equipment, may generate a part for performing functions described in the flowchart blocks. To implement a function in a particular manner, the computer program instructions may also be stored in a computer-usable or computer-readable memory that may direct a computer or other programmable data processing equipment. Thus, the instructions stored in the computer usable or computer readable memory may be produced as an article of manufacture containing an instruction part for performing the functions described in the flowchart blocks. The computer program instructions may be embodied in a computer or other programmable data processing equipment. Thus, a series of operations may be performed in a computer or other programmable data processing equipment to create a computer-executed process, and the computer or other programmable data processing equipment may provide steps for performing the functions described in the flowchart blocks.

Additionally, each block may represent a module, a segment, or a portion of code that includes one or more executable instructions for executing a specified logical function(s). It should also be noted that in some alternative implementations the functions recited in the blocks may occur out of order. For example, two blocks shown one after another may be performed substantially at the same time, or the blocks may sometimes be performed in the reverse order according to a corresponding function.

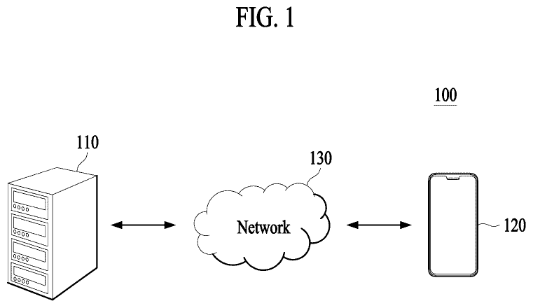

FIG. 1 is a schematic configuration diagram illustrating an environment in which an electronic apparatus operates according to an example embodiment. Referring to FIG. 1, an electronic apparatus 110 and a user terminal 120 may communicate with each other through a connected network 130, or with other external apparatuses.

The network 130 may include a local area network (LAN), a wide area network (WAN), a value added network (VAN), a mobile radio communication network, a satellite communication network and combinations thereof. The network 130 is a comprehensive data communication network that enables each element illustrated in FIG. 1 to communicate smoothly with each other, and may include a wired Internet network, a wireless Internet network and a mobile wireless communication network. Wireless communication technologies used in the network 130 includes, for example, wireless LAN (wi-fi), Bluetooth, Bluetooth low energy (BLE), ZigBee, wi-fi direct (WFD), ultra wideband (UWB), infrared data association (IrDA) and near field communication (NFC), but it is not limited thereto.

The electronic apparatus 110 may use price data of various assets (stocks, coins, real estate and so on) over time. In the case of listed stocks, stock prices data of companies listed on the stock market (for example, KOSPI and KOSDAQ) may be used, and in the case of unlisted stock, stock price data of companies traded in the unlisted stock market (for example, KONEX and K-OTC) may be used. In the case of coins, price data of coins traded on a centralized exchange (CEX) or a decentralized exchange (DEX) may be used. In the case of real estate, actual transaction data provided by the Ministry of Land, Infrastructure and Transport, and local governments may be used. However, the source of the asset price data used by the electronic apparatus 110 is not limited by the above.

The electronic apparatus 110 may identify an extremum point in the price flow of each asset. In the present disclosure, an “extremum point” refers to a high or a low of an asset's price, and since the asset price can fluctuate over time, the “extremum point” in a given time period indicates a high and a low of the asset price in that time period. Further, the electronic apparatus 110 trains an artificial intelligence (AI) model, and determines whether the current price or a price at a specific timepoint of the same asset or another related asset is close to the high or the low. The electronic apparatus 110 controls a dedicated application installed in the user terminal 120 to provide a chart of asset price trends over time, and information generated by the electronic apparatus 110 may be additionally provided to help the user in asset management.

The electronic apparatus 110 may be one server that performs the process, but is not limited to one server. According to an example embodiment, the electronic apparatus 110 may refer to a group in which a plurality of servers are electronically or physically connected. Meanwhile, the user terminal 120 may access a service provided by the electronic apparatus 110 by a user's manipulation and display information received from the electronic apparatus 110 on a screen. The user terminal 120 may receive a user's input through an input interface, and the user terminal 120 may transmit an output corresponding to the user's input to the electronic apparatus 110 through an output interface or display it on the screen of the user terminal 120.

The user terminal 120 is represented by a PC, a tablet and a smartphone, and a user may access a website or an application serviced by the electronic apparatus 110 and receive price-related information.

In relation to the above, it will be described in more detail with the following drawings. The methods illustrated in the drawings below may be performed by, for example, the electronic apparatus 110 described above. Further, in the flowcharts illustrated below, each method is divided into a plurality of operations and described, but at least some of the operations may be performed out of order, at least some of the operations may be performed in combination with other operations, at least some of operations may be omitted, at least some of the operations may be divided into detailed operations and performed, or one or more not illustrated operations may be added and performed.

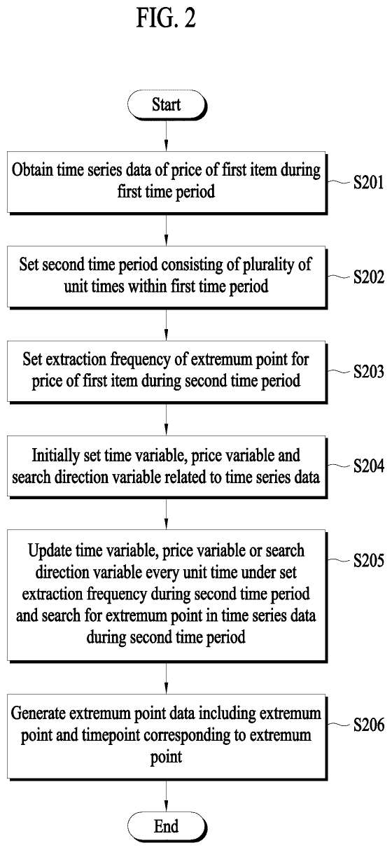

FIG. 2 is a flowchart of a method for providing price-related information according to the first example embodiment.

In the first example embodiment, in operation S201, the electronic apparatus 110 may obtain time series data of a price of a first item during a first time period. In the present disclosure, an “item” may collectively refer to a name, a ticker, a label and a tag for distinguishing a corresponding asset in a market where assets such as stocks, coins and real estate are traded. In other words, the “item” indicates a delimiter that can specify an asset. Further, in the present disclosure, “time series data” may indicate a set of data arranged at specific time intervals. Each piece of data may indicate a specific time and the price of an asset at the specific time. The time interval in which time series data is placed is not necessarily constant throughout the time series data, and may be different for each phase in which the time series data is arranged. Further, time series data arranged at time interval A may be reconstructed at time interval B that is greater than time interval A. For example, the time series data in “days” may be reconstructed in time series data in “months” or “years” according to a user's request or the setting of the electronic apparatus 110.

In operation S202, the electronic apparatus 110 may set a second time period consisting of a plurality of unit times within the first time period. The second time period need not necessarily be a continuous time period, and according to an example embodiment, the second time period may collectively refer to a plurality of discontinuous time periods. The second time period is a time period in which extremum point data to be referenced for investment is to be generated, and the electronic apparatus 110 may set the second time period based on various methods. For example, the electronic apparatus 110 may set one or more time period within the first time period among the time periods designated as analysis targets according to the request of the user terminal 120 as the second time period. As another example, the electronic apparatus 110 may set one or more time period in which the price volatility of the first item in the first time period is greater than or equal to a reference value, the highest of the price is greater than or equal to a specific price, or the lowest of the price is less than or equal to a specific price as the second time period. Price volatility in a time period may also be defined according to various criteria, and for example, price volatility in a time period may be defined in proportion to the difference between the highest and the lowest of the price in the time period, or may be defined in proportion to the maximum variance of the price per unit time within the time period. As another example, the electronic apparatus 110 may set the recommended time period in the first time period as the second time period using the AI model learned based on the previously accumulated analysis data on the first item. Meanwhile, a method of setting the second time period is not limited to the above-described example. In the present disclosure, the unit time on the time axis of “time series data” may be typically set to day, month and year, but according to an example embodiment, the unit time may be subdivided into hours, minutes and so on. Further, when the time series data is exposed to the user, the unit time is not fixed, but may be changed according to the user's choice.

In operation S203, the electronic apparatus 110 may set the extraction frequency of the extremum point for the price of the first item during the second time period. In the present disclosure, “extraction frequency” is a variable that affects whether the criteria for an extremum point to be searched are set to be difficult to meet or relatively easy to meet. If the extraction frequency is set high, a relatively large number of extremum points that meet the set criteria may be searched. If the extraction frequency is set low, extremum points that meet the set criteria may become relatively rare. Further, in the present disclosure, the “extraction frequency” may also be explained in relation to the “strength” of the extremum point. For example, the strength of an extremum point found under a relatively high first extraction frequency but not found under a lower second extraction frequency is lower than the strength of an extremum point searched under both the first extraction frequency and the second extraction frequency. In other words, strength of an extremum point may represent the degree to which the extremum point easily satisfies a criterion for being searched for.

In an example embodiment, the electronic apparatus 110 may set the extraction frequency of the extremum point based on at least one of the volatility, the highest and the lowest of the price of the first item. For example, if the difference between the highest price and the lowest price of the first item is large or the volatility is large, the electronic apparatus 110 may quickly respond to changes by identifying many extremum points by setting the extraction frequency of extremum points high. In the opposite case, the extraction frequency of the extremum point may be set low, and only the extremum point from a longer-term perspective may be referred to for investment. Further, the electronic apparatus 110 may set the extraction frequency of the extremum point for each detailed time period including one or more unit times in the second time period. In other words, the electronic apparatus 110 may set the extraction frequency of the extremum point for each detailed time period based on at least one of the volatility, the highest, and the lowest of the price of the first item for each detailed time period.

In another example embodiment, the electronic apparatus 110 may set the extraction frequency of the extremum point according to an asset market in which the first item is traded, a type of asset according to the first item or an identifier of the first item (for example, a ticker and an item code). This is in consideration of the fact that the degree of price volatility or rise and fall may vary depending on the market to which the asset belongs, the type of asset or the item of the asset itself. For example, in the case of coins with higher volatility than government bonds, the extraction frequency of the extremum point can be set high to efficiently grasp the frequently changing asset price. In other words, among coins, different extraction frequencies may be applied to Bitcoin, which has a large market capitalization and relatively low volatility, and alternative coin, which has relatively high volatility.

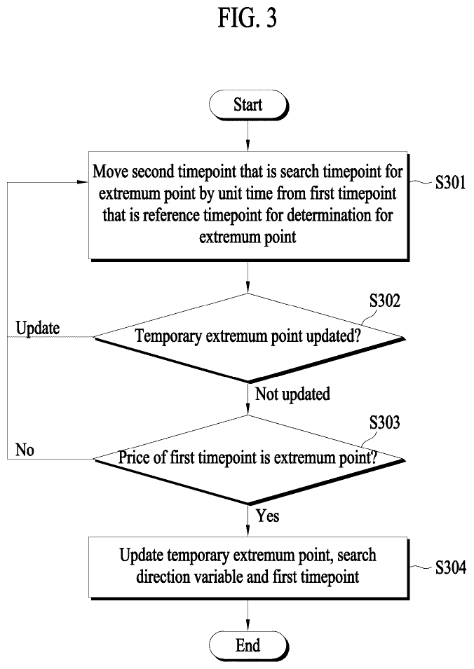

In operation S204, the electronic apparatus 110 may initially set a time variable related to time series data, a price variable and a search direction variable corresponding to the type of extremum point that is to be searched. In an example embodiment, the time variable may include a first timepoint, which is a reference timepoint for determining an extremum point, and a second timepoint, which is a search timepoint for an extremum point. A “second timepoint” indicates every timepoint to search for an extremum point. The “first timepoint” indicates the timepoint of the price that becomes the reference when determining whether the price of the second timepoint corresponds to the extremum point. Meanwhile, the price variable may include a temporary extremum point for the price of the first item. A “temporary extremum point” refers to an extremum point that is temporarily set to determine an extremum point when a series of extremum point searching processes are performed. In the present disclosure, the “search direction variable” is initially set to 0, and depending on whether the price of the asset rises or falls as the search proceeds from the first timepoint to the temporary extremum point, the “search direction variable” has values of +1 and −1. The process described below with reference to FIGS. 3 to 5 presupposes the definition of the above variables.

In operation S205, during the second time period, the electronic apparatus 110 may update the time variable, the price variable or the search direction variable every unit time under the set extraction frequency and search for an extremum point in the time series data. For a quantitative determination regarding extremum points, calculations using time variables, price variables and search direction variables must be performed, and thus operation S204 is an initial setting process of variables, and operation S205 is a process of updating the variables and iterating determination of an extremum point at each timepoint within the second time period. Therefore, it indicates that an extremum point is determined for all timepoints in the second time period in operation S205.

In operation S206, the electronic apparatus 110 may generate extremum point data including extremum points and timepoints corresponding to the extremum points. In the present disclosure, the “extremum point data” does not necessarily mean data that includes both high and low information, and the “extremum point data” may indicate that only one of information about high or information about low is included.

The generated extremum point data may be matched with one or more high prices and a corresponding timepoint for each high price, the generated extremum point data may be in the form of a table in which one or more low prices and corresponding timepoints are matched to each low price, and the generated extremum point data may have a form in which a high price table and a correspondence point table are associated, and a low price table and a correspondence point table are associated. However, the form of extremum point data is not limited thereto. If the asset's price (or price range from a low to a high) can be specified according to the timepoint, it may be generated in various forms.

For example, based on time series data for about 5 years (a first time period) from Jan. 1, 2015 to Dec. 31, 2019 on the stock price of company A listed on the KOSPI, the electronic apparatus 110 may generate extremum point data on the price of company A for about one year (a second time period) from Jan. 1, 2017 to Dec. 31, 2017. As described above, the second time period does not mean only a single continuous time period included in the first time period, and the second time period may collectively refer to two or more discontinuous phases within the first time period. For example, the second time period may be set to two phases of Jan. 1, 2017 to May 31, 2017 and Oct. 1, 2017 to Dec. 31, 2017. For another example, the second time period may be set to five phases corresponding to the fourth quarter (October to December of each year) of each year of Jan. 1, 2015 to Dec. 31, 2019.

According to the first example embodiment, the electronic apparatus 110 may generate data on an extremum point of an asset that may affect a decision on whether to trade the asset. Existing various stock services and commodity trading services provide detailed technical indicators for investors to refer to. However, the detailed technical indicators are not intuitive, and it is difficult for most investors to refer to them because the investors do not have background knowledge about the indicators. However, information such as a high and a low is very intuitive and easy to be displayed on the screen of the user terminal 120, so it functions as a powerful indicator that can be referred to when users invest.

In the first example embodiment, the extremum point data generated by the electronic apparatus 110 may be divided into a plurality of levels representing the strength of the extremum point. For example, the extremum point data generated by the electronic apparatus 110 may be divided into four levels according to the strength, and each level may be classified according to a ratio (a first price ratio and a second price ratio that will be described later) that is a criterion for determining an extremum point.

The level representing the strength of the extremum point may have a correlation with the extraction frequency that is set in operation S203. For example, the higher the extraction frequency is set, the lower limit of the searchable extremum point level may be lowered, and the lower the extraction frequency is set, the higher the lower limit of the searchable extremum point level may be. In the present disclosure, an extremum point with high strength (a strong extremum point) means an extremum point from a longer-term perspective and an extremum point with low strength (a weak extremum point) means a relatively short extremum point, and thus all strong extremum points will be included in relatively weak extremum points as well, and as the lower limit of the searchable extremum point level is higher, only extremum points from a longer-term perspective will be searched. In other words, by adjusting the extraction frequency, the electronic apparatus 110 may search all of the extremum points in a relatively short term or may search only extremum points of a longer-term perspective.

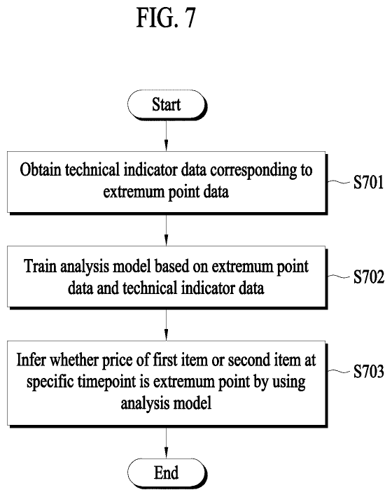

In addition, the extremum point data classified according to the strength of the extremum point may be used for training an AI-based model for the purpose of inferring whether the price at a specific point corresponds to the extremum point. Specifically, the electronic apparatus 110 may train an AI-based model using extremum point data in a form in which the strength of the extremum point is labeled at the timepoint corresponding to the extremum point and the extremum point, and the electronic apparatus 110 may infer whether the price of a first item or an item related to thereto at a specific timepoint is an extremum point by using the trained model. In this regard, it will be described later in more detail with reference to FIG. 7 below.

FIGS. 3 to 5 are flowcharts of a method for providing price-related information specified based on the first example embodiment.

FIG. 3 illustrates an example embodiment in which operation S205 in which the electronic apparatus 110 searches for an extremum point is embodied. In the example embodiment, in operation S301, the electronic apparatus 110 may move a second timepoint by a set unit time from the first timepoint. In operation S302, the electronic apparatus 110 may determine whether to update the temporary extremum point by comparing the temporary extremum point and the second timepoint. In operation S303, if the temporary extremum point is not updated, the electronic apparatus 110 may determine whether the price of the first timepoint is an extremum point by comparing the price of the first timepoint, the price of the second timepoint and a temporary extremum point according to the search direction corresponding to the search direction variable. If the temporary extremum point is updated, the electronic apparatus 110 may move the second timepoint by a unit time (repetition of operation S301). In operation S304, if the price of the first timepoint is determined to be an extremum point according to operation S303, the electronic apparatus 110 may update the temporary extremum point, the search direction variable and the first timepoint. If it is determined that the price of the first timepoint is not an extremum point according to operation S303, the electronic apparatus 110 may move the second timepoint by the unit time (repetition of operation S301).

As an example embodiment of operation S302, the electronic apparatus 110 may update the temporary low to the price of the second timepoint when the price of the second timepoint is lower than the temporary low of the temporary extremum points, and if the price of the second timepoint is higher than the temporary high that is the temporary extremum point, the electronic apparatus 110 may update the temporary high to the price of the second timepoint. On the other hand, if the price of the second timepoint is higher than the temporary low, the electronic apparatus 110 may maintain the current temporary low, and if the price of the second timepoint is lower than the temporary high, the electronic apparatus 110 may maintain the current temporary high. According thereto, the temporary low (the temporary high) would be the lowest (highest) asset price passed through as the second timepoint moves by the unit time in the direction of the time axis until a new high or low is identified.

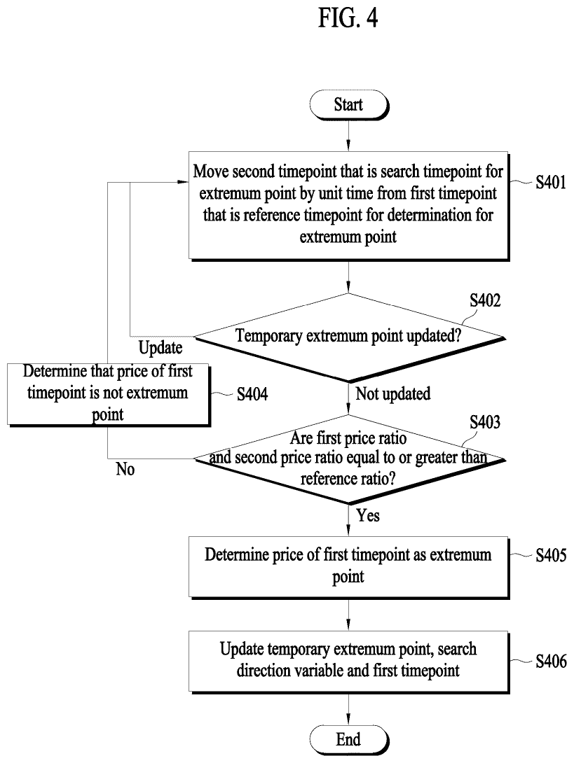

Further, FIG. 4 illustrates an example embodiment in which operation S303 in which the electronic apparatus 110 determines whether the price of the first timepoint is an extremum point is embodied. In the example embodiment, in operation S401, the electronic apparatus 110 may move the second timepoint by a set unit time from the first timepoint. In operation S402, the electronic apparatus 110 may determine whether to update the temporary extremum point by comparing the temporary extremum point and price of the second timepoint. In operation S404, if the temporary extremum point is not updated and if at least one of the first price ratio based on the temporary extremum point and price of the first timepoint and the second price ratio based on the temporary extremum point and price of the second timepoint is less than the reference ratio that is set according to the extraction frequency, the electronic apparatus 110 may determine that the price of the first timepoint is not an extremum point. However, in operation S405, if the temporary extremum point is not updated and the first price ratio and the second price ratio are greater than or equal to the reference ratio, the electronic apparatus 110 may determine the price of the first timepoint as an extremum point. In operation S406, the electronic apparatus 110 may update the temporary extremum point, the search direction variable and the first timepoint. If the temporary extremum point is updated according to operation S402 or if it is determined that the price of the first timepoint is not an extremum point according to operation S403, the electronic apparatus 110 may move the second timepoint by the unit time (repetition of operation S401).

In an example embodiment, the first price ratio may be calculated by dividing the difference between the price of the first timepoint and the temporary extremum point by the price of the first timepoint. For example, the “first price ratio based on the price of the first timepoint and the temporary low” may be calculated by dividing the difference between the price of the first timepoint and the temporary low by the price of the first timepoint, and the “first price ratio based on the price of the first timepoint and the temporary high” may be calculated by dividing the difference between the temporary high and the price of the first timepoint by the price of the first timepoint.

Further, in an example embodiment, the second price ratio may be calculated by dividing the difference between the price of the second timepoint and the temporary extremum point by the price of the second timepoint. For example, the “second price ratio based on the price of the second timepoint and the temporary low” may be calculated by dividing the difference between the price of the second timepoint and the temporary low by the price of the second timepoint, and the “second price ratio based on the price of the second timepoint and the temporary high” may be calculated by dividing the difference between the temporary high and the price of the second timepoint by the price of the second timepoint.

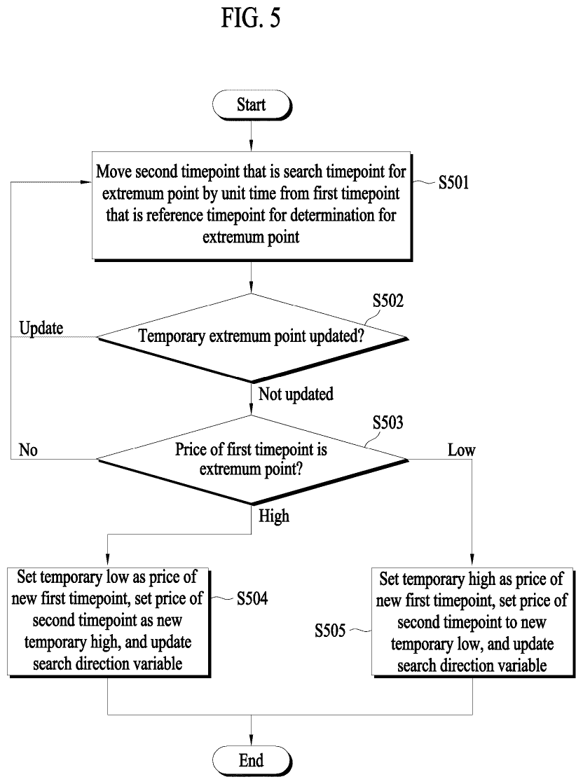

Further, FIG. 5 illustrates an example embodiment in which operation S304 in which the electronic apparatus 110 updates a temporary extremum point, a search direction variable and a first timepoint is embodied. In the example embodiment, in operation S501, the electronic apparatus 110 may move the second timepoint by a set unit time from the first timepoint. In operation S502, the electronic apparatus 110 may determine whether to update the temporary extremum point by comparing the temporary extremum point and price of the second timepoint. In operation 503, if the temporary extremum point is not updated, the electronic apparatus 110 may determine whether the price of the first timepoint is an extremum point by comparing the price of the first timepoint, the price of the second timepoint and a temporary extremum point according to the search direction corresponding to the search direction variable. If the temporary extremum point is updated, the electronic apparatus 110 moves the second timepoint by the unit time (repetition of operation S501). In operation S504, if the price of the first timepoint is determined to be a high according to operation S503, the electronic apparatus 110 may set the temporary low as the price of the new first timepoint, set the price of the second timepoint as a new temporary high, and update the search direction variable. Further, in operation S505, if the price of the first timepoint is determined to be a low according to operation S503, the electronic apparatus 110 may set the temporary high as the price of the new first timepoint, set the price of the second timepoint to a new temporary low, and update the search direction variable. If it is determined that the price of the first timepoint is not an extremum point according to operation S503, the electronic apparatus 110 may move the second timepoint by the unit time (repetition of operation S501).

Processes of searching an extremum point of FIGS. 4 and 5 will be described in detail as follows.

When the value of the search direction variable is 0, the following process may be proceeded. If the first price ratio and the second price ratio calculated using the temporary low are greater than or equal to the reference ratio, the electronic apparatus 110 may determine the first timepoint as a high, set the temporary low to the price of a new first timepoint, set the second timepoint's price to a new temporary high (or a new temporary low), and update the value of the search direction variable to 1. Further, if the first price ratio and the second price ratio calculated using the temporary high are greater than or equal to the reference ratio, the electronic apparatus 110 may determine the first timepoint as a low, set the temporary high to the price of the new first timepoint, set the second timepoint's price to a new temporary low (or a new temporary high), and update the value of the search direction variable to −1.

Further, when the value of the search direction variable is −1, if the first price ratio and the second price ratio calculated using the temporary low are greater than or equal to the reference ratio, the electronic apparatus 110 may determine the first timepoint as a high, set the temporary low to the price of the new first timepoint, set the second timepoint's price to a new temporary high (or a new temporary low), and change the value of the search direction variable to +1.

Further, when the value of the search direction variable is +1, if the first price ratio and the second price ratio calculated using the temporary high are greater than or equal to the reference ratio, the electronic apparatus 110 may determine the first timepoint as a low, set the temporary high to the price of the new first timepoint, set the second timepoint's price to a new temporary low (or a new temporary high), and change the value of the search direction variable to −1.

However, when the above search process is applied to some items with high volatility, extremum points may be excessively searched. To prevent this, conditions related to trading dates may be additionally set for some items with high volatility. The following explains this in detail.

When the value of the search direction variable is 0, the following process may be proceeded. When the first price ratio and the second price ratio calculated using the temporary low are greater than or equal to the reference ratio, if the timepoint of the temporary low and the first timepoint are at least N trading days apart and if there is a difference between the timepoint of the temporary low and the second timepoint by at least N trading days, the electronic apparatus 110 may determine the first timepoint as a high, set the temporary low to the price of the new first timepoint, set the second timepoint's price to new temporary high (or a new temporary low), and update the value of the search direction variable to 1.

Further, if the first price ratio and the second price ratio calculated using the temporary high are greater than or equal to the reference ratio, if the timepoint of the temporary high and the first timepoint are at least N trading days apart, and if there is a difference between the timepoint of the temporary high and the second timepoint by at least N trading days, the electronic apparatus 110 may determine the first timepoint as a low, set the temporary high to the price of the new first timepoint, set the second timepoint's price to a new temporary low (or a new temporary high), and update the value of the search direction variable to −1.

Further, when the value of the search direction variable is −1, if the first price ratio and the second price ratio calculated using the temporary low are greater than or equal to the reference ratio and the timepoint of the temporary low and the first timepoint differ by at least N trading days and if there is a difference between the timepoint of the temporary low and the second timepoint by at least N trading days, the electronic apparatus 110 may determine the first timepoint as a high, set the temporary low to the price of the new first timepoint, set the second timepoint's price to a new temporary high (or a new temporary low), and change the value of the search direction variable to +1.

Further, when the value of the search direction variable is +1, if the first price ratio and the second price ratio calculated using the temporary high are greater than or equal to the reference ratio and the timepoint of the temporary high and the first timepoint differ by at least N trading days and if there is a difference between the timepoint of the temporary high and the second timepoint by at least N trading days, the electronic apparatus 110 may determine the first timepoint as a low, set the temporary high to the price of the new first timepoint, set the second timepoint's price to a new temporary low (or a new temporary high), and change the value of the search direction variable to −1.

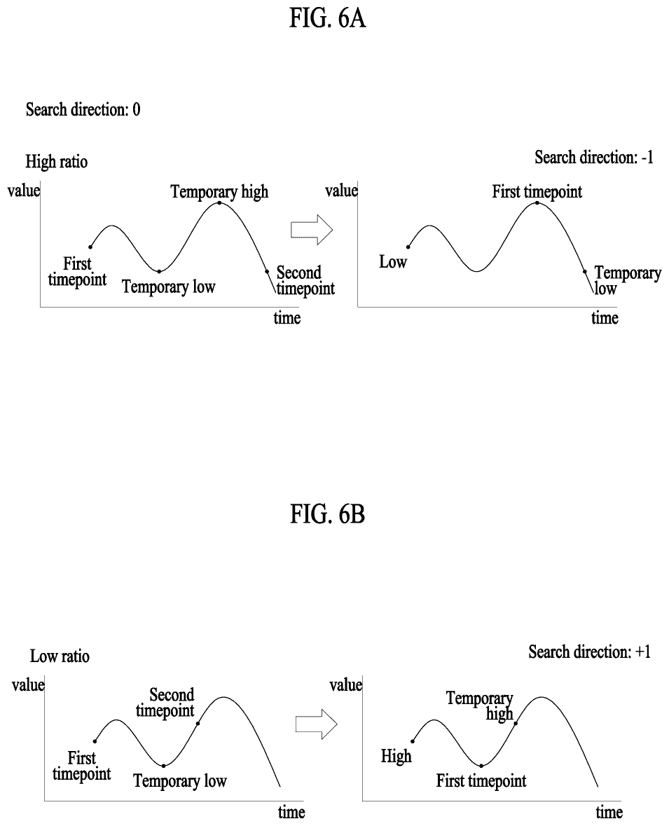

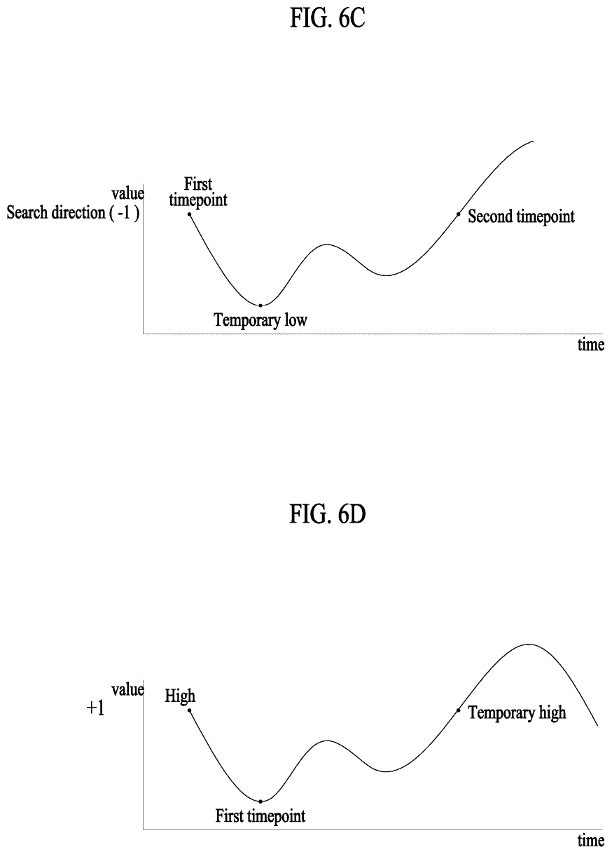

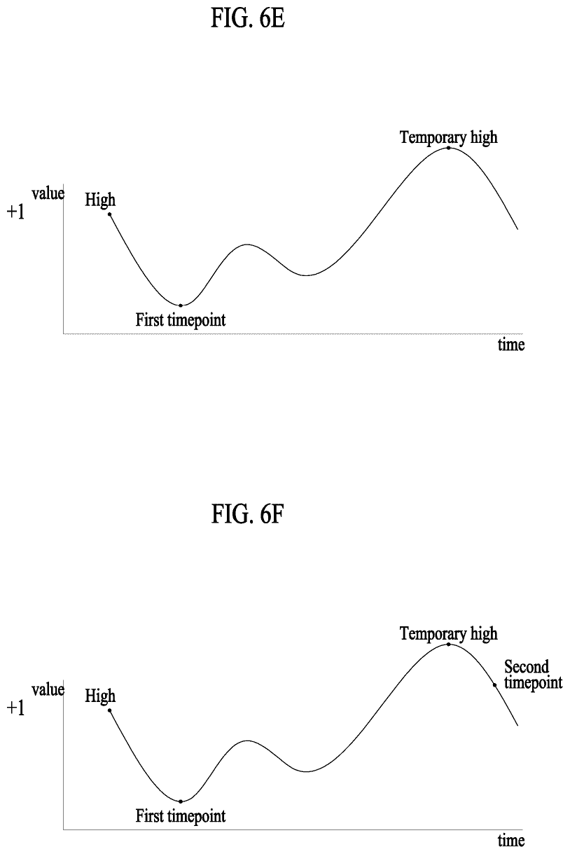

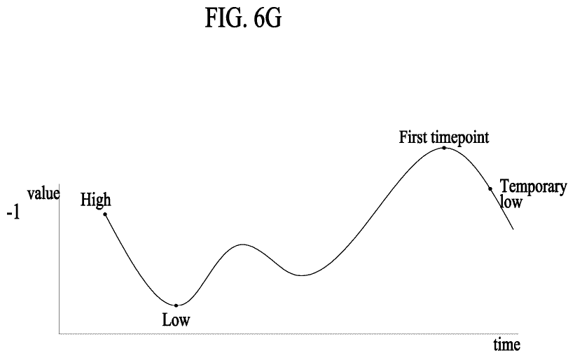

The process of searching an extremum point and the process of updating variables specified in FIGS. 4 and 5 will be described later in detail with reference to FIGS. 6A to 6G. FIGS. 6A to 6G are exemplary diagrams illustrating a process of determining an extremum point of a price according to a search direction.

FIGS. 6A and 6B illustrate a search process in a state in which a search direction variable is initially set to 0. FIG. 6A illustrates a search process when the reference ratio for the first price ratio and the second price ratio is set relatively high, and FIG. 6B illustrates a search process when the reference ratio is set relatively low. It is assumed that the initial temporary low (or a temporary high) is set at the price of the first timepoint.

In FIG. 6A, the second timepoint moves from the first timepoint to the right by a unit time (for example, a year, a month, a day and a minute) and passes through a point on the graph. Since the initial values of the temporary high and the temporary low are set to a price of the first timepoint, the temporary high is updated up to the first extremum point convex upward, and then the temporary high is updated to the value of the second extremum point convex upward as it passes the second extremum point. Further, the temporary low is updated with the first extremum point convex down. The difference between the price of the first timepoint and the temporary low (the numerator element of the first price ratio) and the difference between the price of the second timepoint and the temporary low (the numerator element of the second price ratio) must be relatively large before the variables are updated. However, since the reference ratio is set relatively high and the temporary low is not that low, the price of the first timepoint is not determined as a high, and the temporary low is not updated to the price of the new first timepoint. However, since the temporary high is quite high, the difference between the temporary high and price of the first timepoint (the numerator element of the first price ratio) and the difference between the temporary high and price of the second timepoint (the numerator element of the second price ratio) is relatively large, so the variables are updated, and as a result, the price of the first timepoint is determined as a low, and the temporary high is updated to the price of the new first timepoint. Further, the price at the second timepoint is updated to a temporary low and the value of the search direction variable is changed to −1, and from the temporary low, the second timepoint moves to the right along the graph, and the search process proceeds again.

Further, FIG. 6B illustrates a case where the reference ratio is set relatively low. The difference between the price of the first timepoint and the temporary low (the numerator element of the first price ratio) and the difference between the price of the second timepoint and the temporary low (the numerator element of the second price ratio) are equal to or greater than a reference value, and thus the price of the first timepoint is determined as a high, the temporary low is updated to the price of the new first timepoint, and the price at the second timepoint is updated to a temporary high. The value of the search direction variable is changed to +1, and from the new temporary high, the second timepoint moves to the right along the graph, and the search process proceeds again.

Meanwhile, FIGS. 6C to 6G illustrate a search process when the value of a search direction variable is −1. As the search process proceeds (while the second timepoint moves to the right along the graph), the variables are updated in the order of FIGS. 6C to 6G.

In FIG. 6C, after the temporary low is updated to the first extremum point convex downward, the second timepoint continued to move to the right with the temporary low unchanged. As the price of the second timepoint moved upward along the graph, the difference between the price of the first timepoint and the temporary low (the numerator element of the first price ratio) and the difference between the price of the second timepoint and the temporary low (the numerator element of the second price ratio) are equal to or greater than the reference value, and accordingly, the variables are updated.

In FIG. 6D, the first timepoint is determined as a high, and the temporary low is updated with the price of the new first timepoint. The price of the second timepoint is updated to a new temporary high, but the temporary high is continuously updated as the price of the second timepoint moved upward along the graph.

In FIG. 6E, the temporary high is updated with the price of the second extremum point convex upward, and then maintained as the graph moves downward. As illustrated in FIG. 6F, as the second timepoint moves along the graph passing the temporary high, the difference between the temporary high and price of the second timepoint (the numerator element of the second price ratio) gradually increases (it is assumed that the difference between the temporary high and price of the first timepoint (the numerator element of the first price ratio) is already above the reference value). As a result, in FIG. 6G, the difference between the temporary high and price of the first timepoint (the numerator element of the first price ratio) and the difference between the temporary high and price of the second timepoint (the numerator element of the second price ratio) are equal to or greater than the reference value, and thus the price of the first timepoint is updated to a low, the temporary high to the price of the first timepoint and the price of the second timepoint to the temporary low.

Further, according to an additional example embodiment, the electronic apparatus 110 does not stop at generating extremum point data, but may train an AI-based model using extremum point data and other data related thereto. In other words, the electronic apparatus 110 may use the generated extremum point data as training data of the model and infer whether the price at a specific timepoint is an extremum point based on the trained model.

FIG. 7 is a flowchart illustrating an additional example embodiment of inferring whether a price at a specific timepoint is an extremum point based on the first example embodiment. In the example embodiment, it is assumed that the electronic apparatus 110 has already performed operation S201 to operation S206 which are operations to that the extremum point data is generated. Then, in operation S701, the electronic apparatus 110 may obtain technical indicator data corresponding to the extremum point data. In operation S702, the electronic apparatus 110 may train an analysis model based on extremum point data and technical indicator data corresponding thereto. In operation S703, the electronic apparatus 110 may infer whether the price of the first item or the second item at a specific timepoint is an extremum point by using the trained analysis model.

As described above, the electronic apparatus 110 may perform inference on a first item that is the basis of data used for training, but the electronic apparatus 110 may also perform inference on a second item separate from the first item. In other words, the electronic apparatus 110 may also perform inference on asset data used for training and a separate asset, and typically, the electronic apparatus 110 may perform inference on the stock price of company B by using the analysis model trained from the stock price data of company A, or perform inference on the price of a fund related to company A (for example, an ETF in which company A is included in a portfolio). This indicates that if the accumulated price data of some companies or funds is insufficient and it is difficult to train satisfactorily with only its own data, the price data of company A, which is highly relevant to the company or fund and has sufficient data, can be used for training.

In an example embodiment, the extremum point data generated by the electronic apparatus 110 may include data labeled with the strength of the extremum point. Using the analysis model trained through this, the electronic apparatus 110 may infer not only the extremum point for the price at a specific timepoint but also the strength of the extremum point. For example, with assumption that the strength of the strongest high is +1 and the strength of the strongest low is −1, the strength of the extremum point in the extremum point data can be labeled, and in this case, the electronic apparatus 110 may infer the strength of an extremum point at a specific timepoint as a real number value between −1 and +1.

In an example embodiment, the technical indicator data may include at least one of MACD, disparity in long-term MA, disparity in short-term MA, a RSI, a stochastic index, a DMI and a position of a price on a Bollinger band.

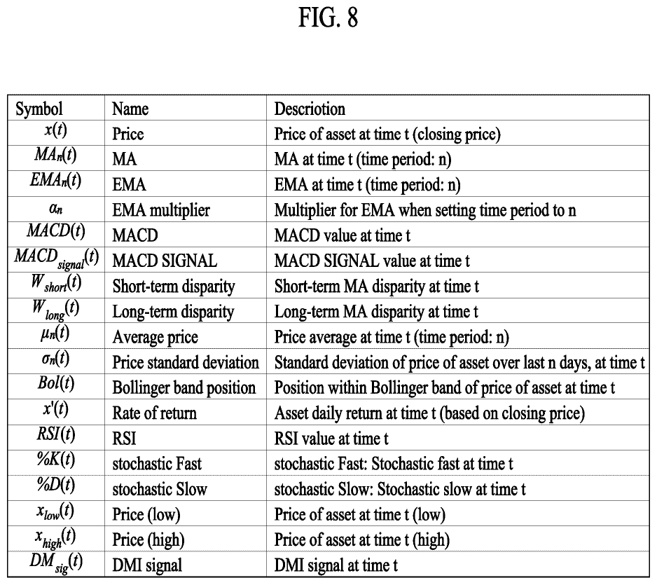

With regard thereto, FIG. 8 illustrates technical indicator data used for training an analysis model. Some of the symbols shown in FIG. 8 are technical indicator data directly used for training of the analysis model, and some are data that is used indirectly to produce technical indicator data that will be used to train the analysis model. For example, MACD, long-term disparity (disparity in long-term MA), short-term disparity (disparity in short-term MA), a RSI, stochastic fast and stochastic slow (a stochastic index), a DMI signal, a Bollinger band position (price position on Bollinger band) are technical indicator data that are used directly, and a price, MA, EMA, EMA multiplier, average price, price standard deviation, rate of return, a price (low) and a price (high) are data that are used indirectly.

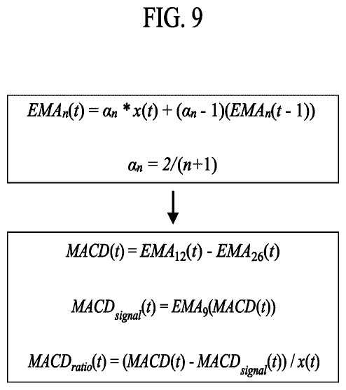

More specifically, FIGS. 9 to 14 illustrate a process of calculating some of technical indicator data. Symbols shown in FIGS. 9 to 14 follow the definitions in FIG. 8.

FIG. 9 illustrates the MACD calculation process. When a time period is set as n, an exponential moving average (EMA) at time t is calculated by adding the product of the EMA multiplier in time period n multiplied by the price at time t to the product of the EMA at time t−1 multiplied by the EMA multiplier in time period n−1. The MACD at time t is calculated by subtracting the long-term EMA from the short-term EMA. Representatively, as shown in FIG. 9, MACD may be calculated by subtracting the 26-day long-term EMA from the 12-day short-term EMA. The MACD signal value at time t may be obtained from the MACD EMA value at time t (typically, n is 9 days), and the ratio of the difference between the MACD and the MACD signal (MACD ratio) can be obtained by using the corresponding values.

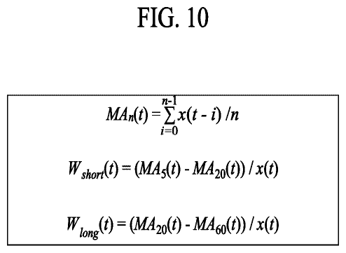

FIG. 10 illustrates a process of calculating disparity in long-term MA and disparity in short-term MA. The MA at time period n and time t is calculated by summing the values obtained by dividing each price from t−n+1 tot by n. The disparity in short-term MA at time t is usually calculated by subtracting the 20-day MA from the 5-day MA and dividing it by the price at time t. The disparity in long-term MA at time t is usually calculated by subtracting the 60-day MA from the 20-day MA and dividing it by the price at time t.

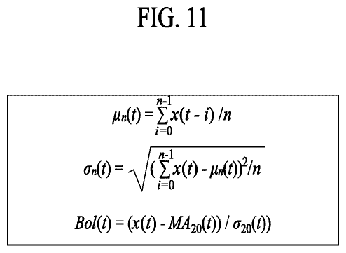

FIG. 11 illustrates the calculation process for the position of the price on the Bollinger band. The Bollinger band usually refers to the upper band (asset price+2*standard deviation) and the lower band (price of asset−2*standard deviation), the upper band and the lower band calculated using the average of asset prices over the last 20 days and standard deviation. First, the sum of prices from t−n+1 to t is divided by n to calculate the average price at timepoint t in time period n, and the standard deviation at time t in time period n is calculated by dividing the sum of the squares of the difference between the price and the average price from 0 to n−1 timepoint by n. Then, the difference between the price at time t and the price average is divided by the standard deviation to calculate the relative position of the corresponding price on the Bollinger band. However, MA may be used instead of average price when calculating a position. FIG. 11 shows a formula using MA.

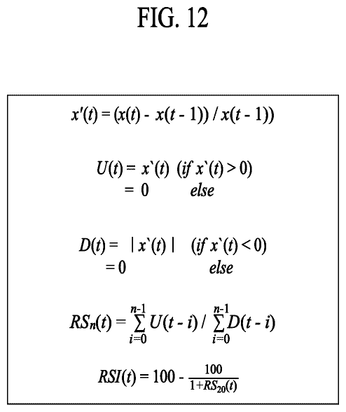

FIG. 12 illustrates a process of calculating a RSI. The rate of return at time t is defined through the price at time t and the price at time t−1, and a function U(t) with a positive rate of return or a value of 0 and a function D(t) with a value of 0 or the absolute value of a negative rate of return are defined. Relative strength (RS) at time period n and time t is calculated by dividing the sum of U from t−n+1 to t by the sum of D, and a RSI at time t is usually calculated using RS for 20 days.

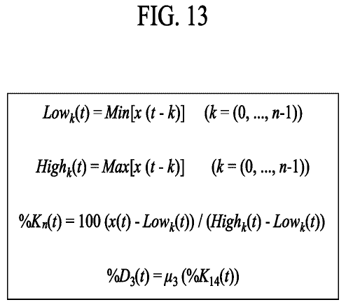

FIG. 13 illustrates a process of calculating a stochastic index. K (stochastic fast) at time t may be obtained through the maximum value (Highₖ(t)) and minimum value (Lowₖ(t)) of the asset price for the last k days, and by using this, D (stochastic slow) may be calculated. Typically, the time period n parameters applied to K and D are 14 and 3, respectively.

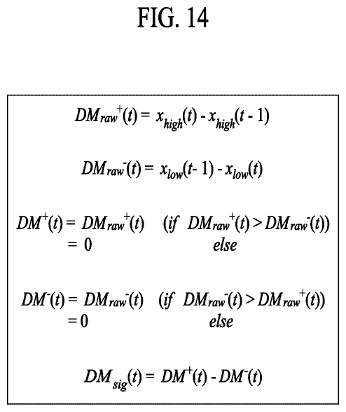

FIG. 14 illustrates a process of calculating DMI. Directional movement (DM) at the high price of the asset and DM at the low price are defined. If the DM at the high price is greater than the DM at the low price, then the DM at the high price is defined, and otherwise, a function DM⁺ of 0 is defined. If the DM at low price is greater than the DM at high price, the DM at low price is defined, and otherwise, a function DM⁻ of 0 is defined. Then, DM⁻ is subtracted from DM⁺ to calculate the DMI signal at time t.

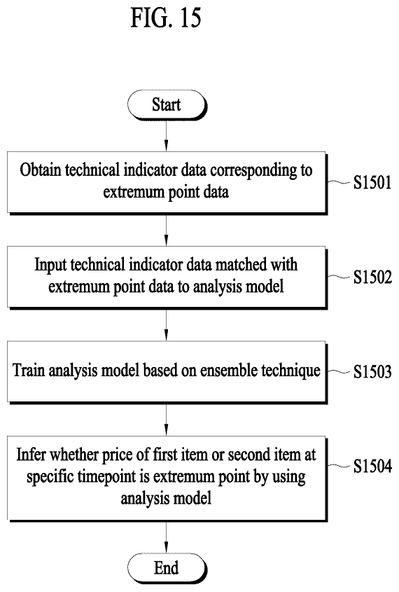

FIG. 15 is a flowchart of an example embodiment of operation S702 related to the training of the analysis model. In the example embodiment, it is assumed that the electronic apparatus 110 has already performed operation S201 to operation S206 which are operations to that the extremum point data is generated. Then, in operation S1501, the electronic apparatus 110 may obtain technical indicator data corresponding to extremum point data. In operation S1502, the electronic apparatus 110 may input technical indicator data matched with extremum point data to the analysis model. In operation S1503, the electronic apparatus 110 may train the analysis model based on an ensemble technique. In operation S1504, the electronic apparatus 110 may infer whether the price of the first item or the second item at a specific timepoint is an extremum point by using the trained analysis model.

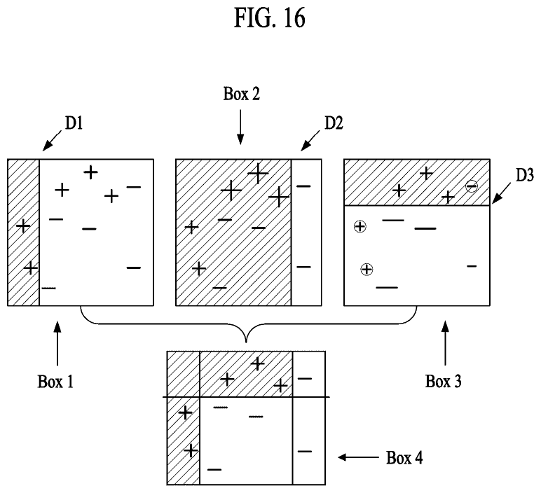

In an example embodiment, the electronic apparatus 110 may train an analysis model based on a boosting algorithm among ensemble techniques. FIG. 16 is a diagram for explaining a boosting algorithm as an example of a training algorithm of an analysis model.

The analysis model sets the boundaries of determination based on technical indicators. However, if there are several types of technical indicators used for training the analysis model, several boundaries may be set, making it impossible to make a correct determination. According to the boosting algorithm, in order to prevent this, a model trained by each technical indicator may be assumed as a weak learner, and the weak learners are sequentially combined, and a weight may be assigned to the output of each weak learner. Prediction may be performed by the next weak learner by increasing the weight for incorrect predictions among the predictions of the previous weak learner. In FIG. 16, a large+sign (increased weight) was displayed in Box 2 for an incorrect prediction in Box 1. Similarly, the incorrect prediction in Box 2 is marked with a large-sign in Box 3. After all predictions are performed, final prediction may be performed using a strong learner that combines weak learners. In FIG. 16, as the weak learner's training results are combined, the boundaries (D1, D2 and D3) are comprehensively considered, and the distinction between + and − is relatively accurate.

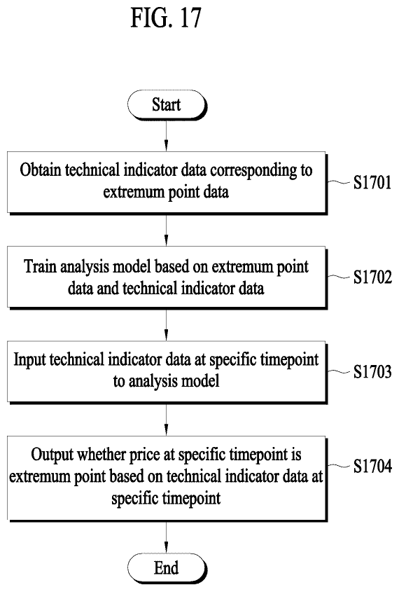

FIG. 17 is a flowchart of an example embodiment of operation S702 related to inference of the analysis model. In the example embodiment, it is assumed that the electronic apparatus 110 has already performed operation S201 to operation S206 which are operations to that the extremum point data is generated. Then, in operation S1701, the electronic apparatus 110 may obtain technical indicator data corresponding to the extremum point data. In operation S1702, the electronic apparatus 110 may train an analysis model based on extremum point data and technical indicator data corresponding thereto. In operation S1703, the electronic apparatus 110 may input technical indicator data at a specific timepoint to be inferred into the trained analysis model. In operation S1704, the electronic apparatus 110 may output whether the price at the specific timepoint is an extremum point based on the technical indicator data at the specific timepoint using the analysis model.

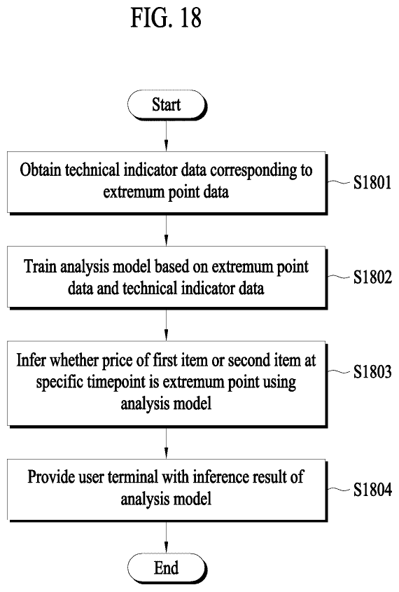

FIG. 18 is a flowchart illustrating an additional example embodiment for providing information to a user terminal based on the example embodiment of FIG. 7. In the example embodiment, it is assumed that the electronic apparatus 110 has already performed operation S201 to operation S206 which are operations to that the extremum point data is generated. In operation S1801, the electronic apparatus 110 may obtain technical indicator data corresponding to the extremum point data. In operation S1802, the electronic apparatus 110 may train an analysis model based on the extremum point data and the technical indicator data corresponding thereto. In operation S1803, the electronic apparatus 110 may infer whether the price of the first item or the second item at a specific timepoint is a high or a low using the trained analysis model. In operation S1804, the electronic apparatus 110 may provide the user terminal 120 with an inference result of an analysis model including whether or not the price at a specific timepoint is an extremum point.

Specifically, a user may specify a timepoint to determine whether the timepoint is an extremum point through the input apparatus of the user terminal 120, and the electronic apparatus 110 may infer whether the price at the specific timepoint is an extremum point and provide the result to the user terminal 120. The user terminal 120 may output whether the price at the corresponding specific timepoint is the extremum point through the provided output apparatus.

As an example embodiment of operation S1804, as an inference result of the analysis model, in addition to whether or not the price at a specific timepoint is an extremum point, the electronic apparatus 110 may further provide the user terminal 120 with at least some of the strength of the extremum point and the strength of technical indicators corresponding to the specific timepoint. Regarding the strength of the extremum point, the electronic apparatus 110 may infer and provide the strength of an extremum point at a specific timepoint within a range of the strength of the extremum point labeled in the extremum point data.

Regarding the strength of the technical indicators, the electronic apparatus 110 may infer and provide the strength of the technical indicators at a specific timepoint within the range of strengths of the technical indicators labeled in the technical indicator data used for training. However, since various technical indicators are considered to infer the extremum point, even when the price at a specific timepoint is inferred to be a high, some technical indicators may be inferred as low signals. For example, assuming that the strength of each of the technical indicators may be inferred to be at least −1 at low and at most +1 at high, even at the point where it is inferred to be high, some technical indicators may be inferred to be 0 or less than 0.

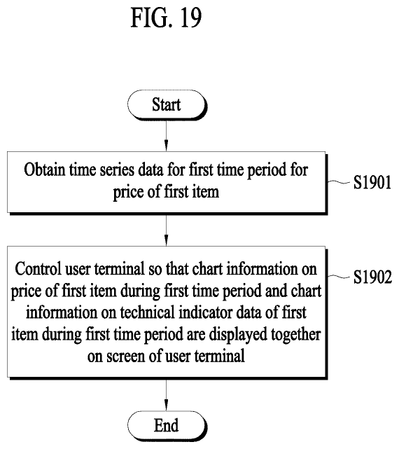

FIG. 19 is a flowchart of a method for providing price-related information according to a second example embodiment.

In the second example embodiment, in operation S1901, the electronic apparatus 110 may obtain time series data for a first time period for price of a first item. In operation S1902, the electronic apparatus 110 may control the user terminal 120 so that chart information on the price of the first item during the first time period and chart information on technical indicator data on the price of the first item during the first time period are displayed together on the screen of the user terminal 120.

In the second example embodiment, the electronic apparatus 110 may control the user terminal 120 so that a chart graph for the price is displayed on a first area of the screen of the user terminal 120 and a chart graph for at least some technical indicator data are displayed in the second area.

Through this, the electronic apparatus 110 may provide the changing flow of each technical indicator to the user, not just the technical indicator at any timepoint specified by the user, and the user may visually recognize and feel the performance of each technical indicator through the past records. Most users prefer to see the price flow of assets from a mid-term perspective to a long-term perspective through charts, and thus if various and complex technical indicators related to assets are provided together with price charts in the form of charts rather than text, users will be encouraged to consider technical indicators much more deeply in their investment.

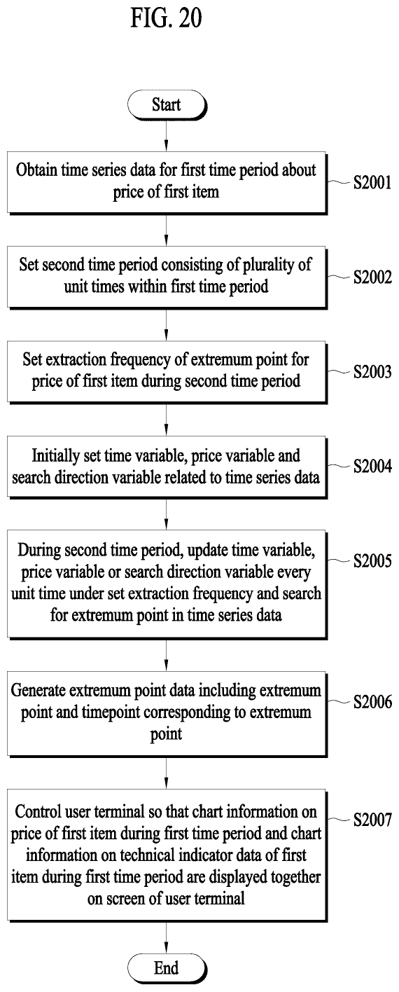

FIG. 20 is a flowchart of an additional example embodiment based on the first and second example embodiments. In the example embodiment, in operation S2001, the electronic apparatus 110 may obtain time series data for a first time period about the price of the first item. In operation S2002, the electronic apparatus 110 may set a second time period consisting of a plurality of unit times within the first time period. In operation S2003, the electronic apparatus 110 may set the extraction frequency of the extremum point for the price of the first item during the second time period. In operation S2004, the electronic apparatus 110 may initially set a time variable, a price variable and a search direction variable related to the time series data, wherein the search direction variable that determines the direction in which to search for an extremum point. In operation S2005, during the second time period, the electronic apparatus 110 may update the time variable, the price variable or the search direction variable every unit time under the set extraction frequency and may search for the extremum point in time series data of the second time period. In operation S2006, the electronic apparatus 110 may generate extremum point data including the extremum point and a timepoint corresponding to the extremum point. In operation S2007, the electronic apparatus 110 may control the user terminal 120 so that chart information on the price of the first item during the first time period and chart information on technical indicator data of the first item during the first time period are displayed together on the screen of the user terminal 120.

In an example embodiment, the electronic apparatus 110 may reflect the extremum point data on the chart information on the price displayed through operation S2007 and provide a chart displaying the extremum point of the price on the screen of the user terminal 120.

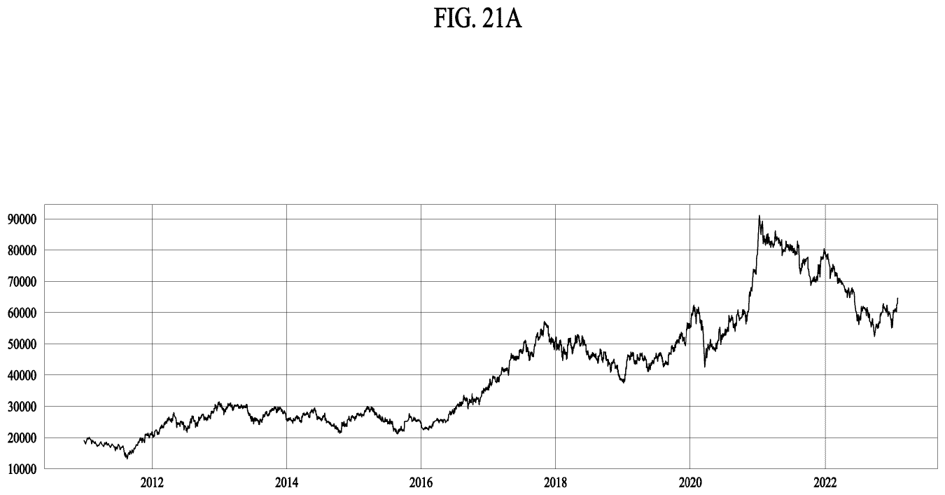

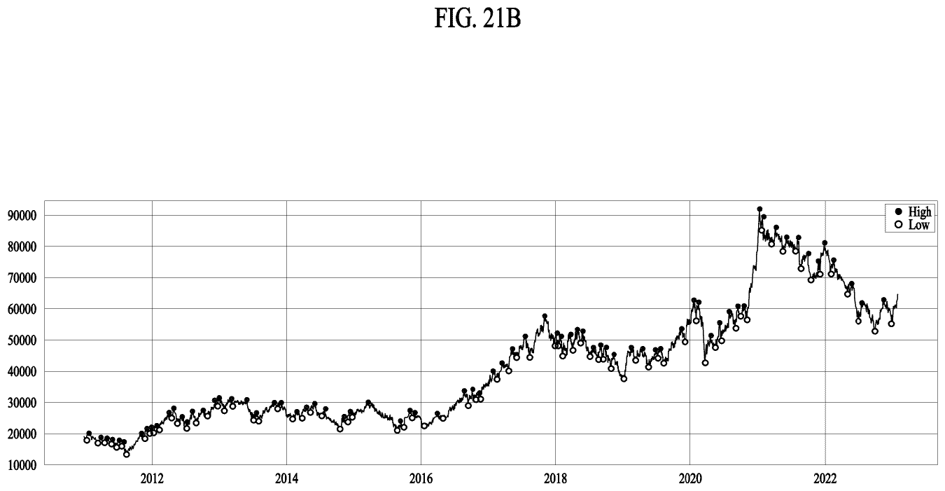

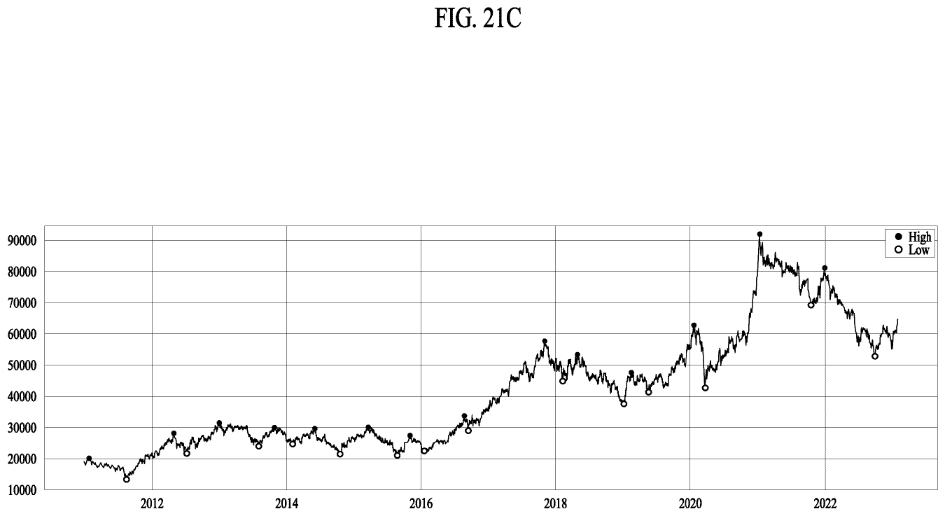

Hereinafter, described will be example embodiments of processes leading to operations of (1) extremum point extraction (generation of extremum point data), (2) the analysis model training, (3) inference of an extreme point, and (4) user terminal control, with respect to FIGS. 21A to 27.

FIGS. 21A to 21C are exemplary diagrams in which extremum point data generated for a price of a specific item is displayed on a price chart. FIG. 21A is a closing price chart of a specific item, and is time series data in which prices at the time of market close for each day are recorded. The electronic apparatus 110 extracts extremum points based on the extraction frequency that is set for all time periods recorded in the closing price chart. FIG. 21B illustrates extremum points extracted by applying a relatively low first price ratio or second price ratio on the chart. FIG. 21C illustrates extremum points extracted by applying a relatively high first price ratio or second price ratio on the chart. In other words, the extremum points illustrated in FIG. 21B are relatively weak extremum points in the short term, and the extremum points illustrated in FIG. 21C are relatively strong extremum points in the long term. All the extremum points illustrated in FIG. 21C are also illustrated in FIG. 21B.

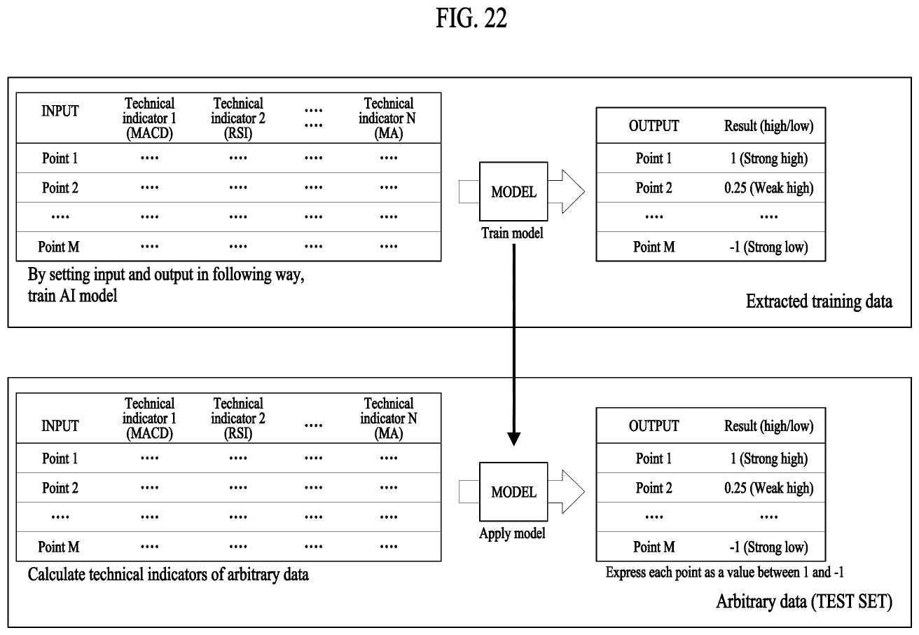

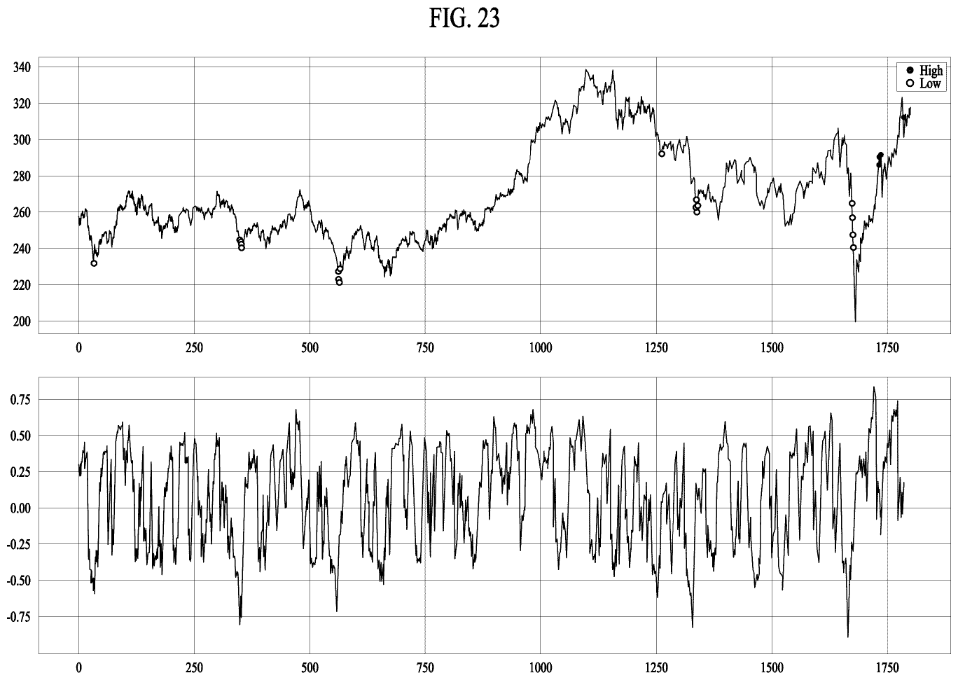

FIG. 22 is an exemplary diagram illustrating a process of training and inferring of an analysis model. As shown in FIG. 21B or 21C, after the extremum points are extracted, by inputting the technical indicator data at each extracted extremum point into the analysis model, the electronic apparatus 110 trains the analysis model in order for the analysis model to determine whether there is an extremum point at each point and determine the strength of the extremum point at each point. Here, it is assumed that the strength of the extremum point used as the ground truth of the training data is discretely labeled, such as −1, 0.25 and 1. After the analysis model is trained, the electronic apparatus 110 uses the technical indicator data at a specific timepoint (point 1 to point M in the bottom table in FIG. 22 are independent of point 1 to point M in the upper table in FIG. 22) as an input for the trained analysis model to infer whether a price at each timepoint is an extremum point and the extremum point strength at each timepoint. FIG. 22 shows that MACD, a RSI and so on are used as technical indicators, but the number and type of technical indicators used for training and inferring may be variously set according to an example embodiment.

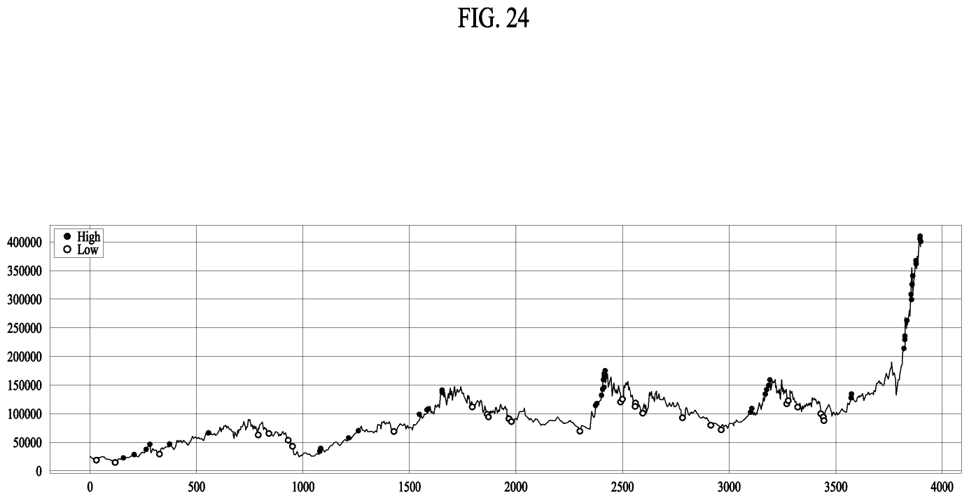

FIGS. 23 and 24 are exemplary diagrams displaying inferred extremum points on price charts. The upper graph of FIG. 23 is a price chart of a specific item, and the bottom graph of FIG. 23 shows the strength of the comprehensive technical indicator for the item. The horizontal axis represents elapsed days with the starting date set to 0. As illustrated, a low is displayed on the price chart when the strength of the technical indicator is approximately −0.5 or less, and a high is marked on the price chart when the strength of the technical indicator is approximately 0.75 or higher. As illustrated in the graphs, the lows and highs extracted through the search process may function as effective investment reference indicators since the lows and the highs correspond to the mid-term to long-term lows or highs of an actual asset, or indicate DM when the asset price fluctuates rapidly.

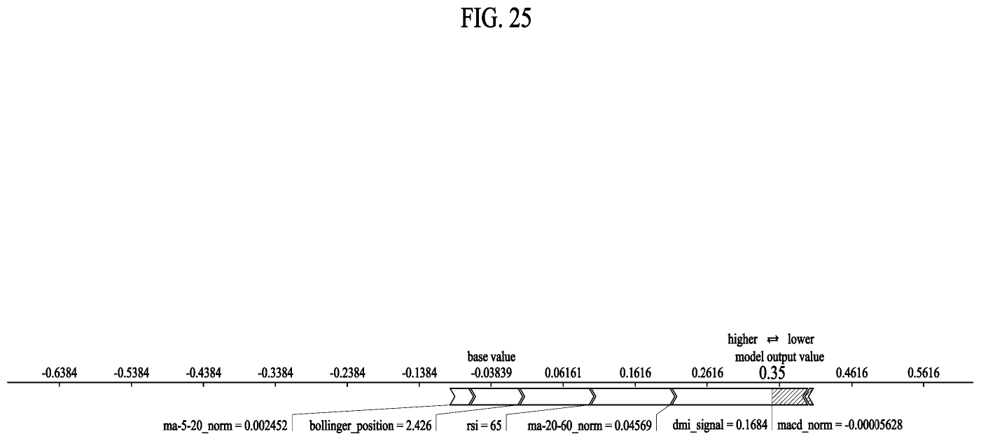

FIGS. 25 to 27 illustrate price-related information displayed on a screen of a user terminal.

FIG. 25 illustrates the proportion of each technical indicator in inferring the extremum point strength of a corresponding price. The unshaded area visually represents the strength of the technical indicator that reinforces high inference (the strength is positive), and the shaded area visually represents the strength of the technical indicator that reinforces the low inference (the strength is negative). Referring to FIG. 25, in order from the left, disparity in short-term MA (0.002452), position of price on the Bollinger band (2.426), RSI (65), disparity in long-term MA (0.04569) and DMI (0.1684) are technical indicators that strengthen high inference, and MACD (−0.00005628) is a technical indicator that reinforces low inference. As a result, the price at the currently specified timepoint is inferred to be a high (strength: 0.35). According to an example embodiment, the weight of each technical indicator in the inference of extremum point strength may be visually expressed in proportion to the length of the bar graph.

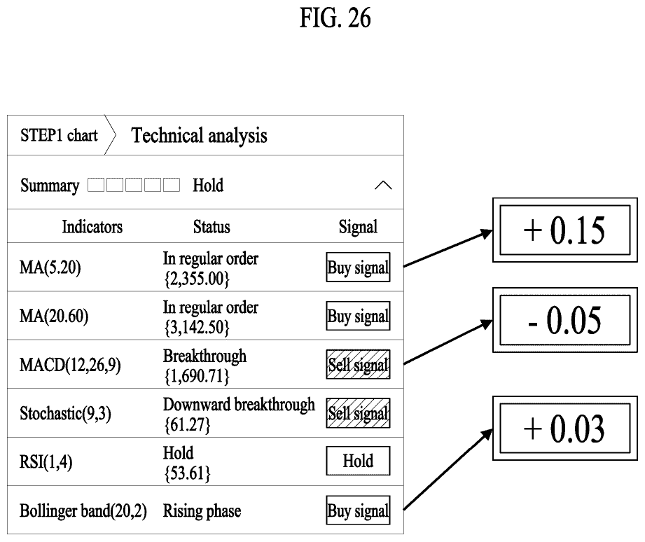

FIG. 26 illustrates an example embodiment in which technical indicators displayed in the form of an existing list are improved. Existing technical indicators such as disparity in short-term MA, disparity in long-term MA, MACD, stochastic indicators, a RSI, and a stock price position on the Bollinger band are displayed only somewhat abstractly, being displayed whether corresponding to a buy signal, a sell signal or a neutral signal. However, according to the example embodiment, by the strength of each technical indicator being inferred, each technical indicator may indicate how strong a buy signal is or how strong a sell signal is. For example, a disparity in short-term MA of +0.15 is a relatively strong buy signal, while a disparity in long-term MA of −0.05 is a relatively weak sell signal, and thus when considered comprehensively, it may be concluded that the current price at the specified time is a price worth considering buying.

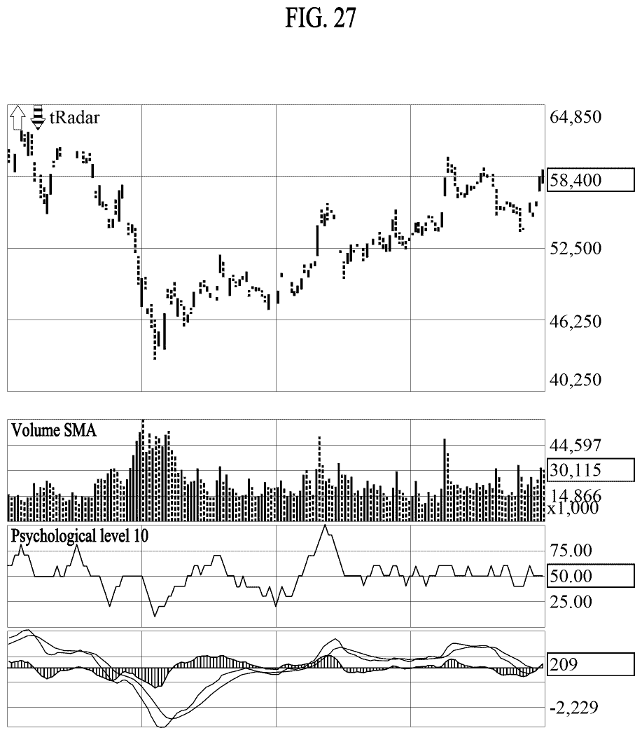

FIG. 27 is an example embodiment of a screen in which a price chart graph of a specific item and a chart graph of a technical indicator are displayed together. Along with the price chart at the top, the trading volume chart, investor sentiment chart and MACD chart for each parameter are shown below. In addition, according to an example embodiment, two or more chart graphs of auxiliary technical indicators may be overlapped and displayed, such as additionally displaying MA lines for each parameter along with the trading volume chart. Through this, the user would often enter the screen on which the price chart graph is displayed, and at the same time, by recognizing the flow of various technical indicators over time, the user may consider the technical indicators more deeply when investing in assets.

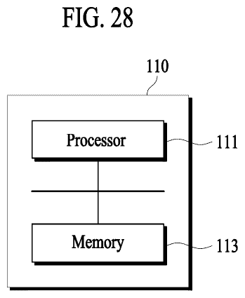

FIG. 28 is a block diagram of the electronic apparatus 110 according to an example embodiment.

The electronic apparatus 110 may include at least one processor 111 and a memory 113 storing at least one instruction executed by the processor, according to an example embodiment. According to an example embodiment, the electronic apparatus 110 may be connected to the user terminal 120 through a transceiver or a communication interface and exchange data.

The processor 111 may perform at least one method described above through FIGS. 1 to 27. The memory 113 may store information for performing at least one method described above through FIGS. 1 to 27. The memory 113 may be volatile memory or non-volatile memory.

The processor 111 may control the electronic apparatus 110 to execute a program and provide information. Program codes executed by the processor 111 may be stored in the memory 113.

According to the first example embodiment, connected to the memory 113, the processor 111 may obtain time series data for a first time period for a price of a first item, set a second time period with a plurality of unit times within the first time period, set an extraction frequency of an extremum point for the price of the first item during the second time period, initially set a time variable, a price variable and a search direction variable related to the time series data, the search direction variable corresponding to the type of the extremum point to be searched, update the time variable, the price variable or the search direction variable in each of the unit times under the extraction frequency during the second time period, and search for the extremum point in the time series data during the second time period, and generate extremum point data including the extremum point and a timepoint corresponding to the extremum point.

Further, according to the second example embodiment, connected to the memory 113, the processor 111 may obtain time series data of the price of the first item during the first time period, and the processor 111 may control a dedicated application in order to provide a chart graph of the price of the first item during the first time period and a chart graph of the technical indicator data of the first item during the first time period together through the dedicated application installed in the user terminal 120.

In FIG. 28, only elements related to the example embodiments of the electronic apparatus 110 are illustrated. Therefore, those skilled in the art may understand that other general-purpose elements may be further included in addition to the elements illustrated in FIG. 28.

The electronic apparatus according to the above-described example embodiments may include a processor, a memory for storing and executing program data, a permanent storage such as a disk drive, and/or a user interface apparatus such as a communication port, a touch panel, a key and/or a button that communicates with an external apparatus. Methods implemented as software modules or algorithms may be stored in a computer-readable recording medium as computer-readable codes or program instructions executable on the processor. Here, the computer-readable recording medium includes a magnetic storage medium (for example, ROMs, RAMS, floppy disks and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control apparatuses. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of an electronic apparatus providing information related to an asset price, the method comprising:
obtaining time series data for a first time period for a price of a first item;
setting a second time period with a plurality of unit times within the first time period;
setting an extraction frequency of an extremum point for the price of the first item during the second time period;
initially setting a time variable, a price variable and a search direction variable related to the time series data, the search direction variable corresponding to a type of the extremum point to be searched;
updating the time variable, the price variable or the search direction variable in each of the unit times under the extraction frequency during the second time period, and searching for the extremum point in the time series data during the second time period; and
generating extremum point data including the extremum point and a timepoint corresponding to the extremum point.

2. The method of claim 1, wherein the extraction frequency is set for each detailed time period including one or more unit times in the second time period,
wherein the extraction frequency that is set for each detailed time period is set based on at least one of volatility, a highest price and a lowest price of the first item for the each detailed time period.

3. The method of claim 1, wherein the extraction frequency is set according to an asset market in which the first item is traded, a type of asset corresponding to the first item or an identifier of the first item.

4. The method of claim 1, wherein the time variable includes a first timepoint which is a reference timepoint for determining the extremum point and a second timepoint which is a search timepoint for the extremum point, and
wherein the price variable includes a temporary extremum point for the price of the first item.

5. The method of claim 4, wherein the searching for the extremum point includes:
moving the second timepoint by a unit time from the first timepoint;
comparing the temporary extremum point with a price of the second timepoint to determine whether to update the temporary extremum point;
if the temporary extremum point is updated, moving the second timepoint by the unit time;
if the temporary extremum point is not updated, determining whether a price of the first timepoint is the extremum point by comparing the price of the first timepoint, the price of the second timepoint and the temporary extremum point according to a search direction corresponding to the search direction variable;
if the price of the first timepoint is determined to be the extremum point, updating the temporary extremum point, the search direction variable and the first timepoint; and
if it is determined that the price of the first timepoint is not the extremum point, moving the second timepoint by the unit time.

6. The method of claim 5, wherein the determining whether to update the temporary extremum point includes:
if the price of the second timepoint is lower than a temporary low that is the temporary extremum point, updating the temporary low with the price of the second timepoint; and
if the price of the second timepoint is higher than a temporary high that is the temporary extremum point, updating the temporary high with the price of the second timepoint.

7. The method of claim 5, wherein the determining whether a price of the first timepoint is the extremum point includes:
if a first price ratio based on the temporary extremum point and the price of the first timepoint and a second price ratio based on the temporary extremum point and the price of the second timepoint are greater than or equal to a reference ratio that is set according to the extraction frequency, determining the price of the first timepoint as the extremum point; and
if at least one of the first price ratio and the second price ratio is less than the reference ratio, determining that the price of the first timepoint is not the extremum point.

8. The method of claim 7, wherein the first price ratio is calculated by dividing a difference between the price of the first timepoint and the temporary extremum point by the price of the first timepoint, and
wherein the second price ratio is calculated by dividing a difference between the price of the second timepoint and the temporary extremum point by the price of the second timepoint.

9. The method of claim 5, wherein the updating includes:
if the price of the first timepoint is determined to be a high that is the extremum point, setting a temporary low that is the temporary extremum point as a price of a new first timepoint, setting the price of the second timepoint as a temporary high that is the temporary extremum point and updating the search direction variable; and
if the price of the first timepoint is determined to be a low that is the extremum point, setting the temporary high as a price of a new first timepoint, setting the price of the second timepoint to a new temporary low and updating the search direction variable.

10. The method of claim 1, further comprising:
obtaining technical indicator data corresponding to the extremum point data;
training an analysis model based on the extremum point data and the technical indicator data; and
inferring whether a price of the first item or a second item at a selected timepoint is the extremum point by using the analysis model.

11. The method of claim 10, wherein the technical indicator data includes at least one of moving average convergence & divergence (MACD), disparity in long-term moving average (MA), disparity in short-term MA, a relative strength index (RSI), a stochastic index, a directional moving index (DMI) and a position of a price on a Bollinger band.

12. The method of claim 10, wherein the training the analysis model includes:
inputting the technical indicator data matched with the extremum point data into the analysis model; and
training the analysis model based on an ensemble technique.

13. The method of claim 10, wherein the inferring includes:
inputting the technical indicator data at the selected timepoint to the analysis model; and
outputting whether the price at the selected timepoint is the extremum point based on the technical indicator data at the selected timepoint.

14. The method of claim 10, wherein the extremum point data includes data labeled with strength of the extremum point, and
wherein the inferring includes inferring whether the price at the selected timepoint is the extremum point, and if the price at the selected timepoint is inferred as the extremum point, further inferring strength of the extremum point.

15. The method of claim 10, further comprising providing a user terminal with an inference result of the analysis model including whether the price at the selected timepoint is the extremum point.

16. The method of claim 15, wherein the inference result of the analysis model further includes at least some of the strength of the extremum point and strength of technical indicators corresponding to the selected timepoint.

17. The method of claim 1, further comprising controlling an user terminal in order for chart information on a price of the first item during the first time period and chart information on technical indicator data of the first item during the first time period to be displayed together on a screen of the user terminal.

18. A computer-readable non-transitory recording medium storing a program for executing a method, the method comprising:
obtaining time series data for a first time period for a price of a first item;
setting a second time period with a plurality of unit times within the first time period;
setting an extraction frequency of an extremum point for the price of the first item during the second time period;
initially setting a time variable, a price variable and a search direction variable related to the time series data, the search direction variable corresponding to a type of the extremum point to be searched;
updating the time variable, the price variable or the search direction variable in each of the unit times under the extraction frequency during the second time period, and searching for the extremum point in the time series data during the second time period; and
generating extremum point data including the extremum point and a timepoint corresponding to the extremum point.

19. An electronic apparatus of providing information related to an asset price, comprising:
at least one processor; and
a memory configured to store one or more instructions executed by the at least one processor,
wherein the at least one processor, by executing the one or more instructions, is configured to:
obtain time series data for a first time period for a price of a first item;
set a second time period with a plurality of unit times within the first time period;
set an extraction frequency of an extremum point for the price of the first item during the second time period;
initially set a time variable, a price variable and a search direction variable related to the time series data, the search direction variable corresponding to a type of the extremum point to be searched;
update the time variable, the price variable or the search direction variable in each of the unit times under the extraction frequency during the second time period, and search for the extremum point in the time series data during the second time period; and
generate extremum point data including the extremum point and a timepoint corresponding to the extremum point.
